(19) United States
(12) Patent Application Publication
(10) Pub. No.: US 2025/0071822 A1
(43) Pub. Date: Feb. 27, 2025

(54) RANDOM ACCESS RESPONSE TRANSMISSION AND RECEPTION TECHNIQUES

(71) Applicant: ZTE Corporation, Shenzhen (CN)

(72) Inventors: Junfeng ZHANG, Shenzhen (CN); Xing LIU, Shenzhen (CN); Xianghui HAN, Shenzhen (CN); Shuaihua KOU, Shenzhen (CN); Xingguang WEI, Shenzhen (CN)

(21) Appl. No.: 18/945,183

(22) Filed: Nov. 12, 2024

Related U.S. Application Data
(63) Continuation of application No. PCT/CN2022/103714, filed on Jul. 4, 2022.

(51) Int. Cl. H04W 74/0833; H04W 72/0446

(52) U.S. Cl. CPC H04W 74/0833; H04W 72/0446

(57) ABSTRACT

Techniques are described for transmission and reception of random access response (RAR) message. An example wireless communication method includes performing, by a communication device, transmissions on a plurality of random access channels; and receiving a message in response to the transmissions on the plurality of random access channels, where a transmission beam with which the communication device is to perform a subsequent transmission after the message is received is identified by information with which the message is scrambled, is identified by information included in the message, or is associated with a time domain location of the message, and where the transmission beam is used for a transmission of a random access channel from the plurality of random access channels.

### CROSS-REFERENCE TO RELATED APPLICATION

This application is a continuation and claims priority to International Application No. PCT/CN2022/103714, filed on Jul. 4, 2022, the disclosure of which is hereby incorporated by reference herein in its entirety.

### TECHNICAL FIELD

This disclosure is directed generally to digital wireless communications.

### BACKGROUND

Mobile telecommunication technologies are moving the world toward an increasingly connected and networked society. In comparison with the existing wireless networks, next generation systems and wireless communication techniques will need to support a much wider range of use-case characteristics and provide a more complex and sophisticated range of access requirements and flexibilities.

Long-Term Evolution (LTE) is a standard for wireless communication for mobile devices and data terminals developed by 3rd Generation Partnership Project (3GPP). LTE Advanced (LTE-A) is a wireless communication standard that enhances the LTE standard. The 5th generation of wireless system, known as 5G, advances the LTE and LTE-A wireless standards and is committed to supporting higher data-rates, large number of connections, ultra-low latency, high reliability and other emerging business needs.

### SUMMARY

Techniques are disclosed for random access response transmission and reception.

A first wireless communication method includes performing, by a communication device, transmissions on a plurality of random access channels; and receiving a message in response to the transmissions on the plurality of random access channels, where a transmission beam with which the communication device is to perform a subsequent transmission after the message is received is identified by information with which the message is scrambled, is identified by information included in the message, or is associated with a time domain location of the message, and where the transmission beam is used for a transmission of a random access channel from the plurality of random access channels.

In some embodiments, the message is a random access response (RAR), the information with which the RAR is scrambled is a random access radio network temporary identifier (RA-RNTI), and the RA-RNTI is a function of: a symbol index of a random access channel occasion, a slot index of the random access channel occasion, a frequency index of the random access channel occasion, a carrier index of a random access channel occasion, and an identifier of the transmission beam. In some embodiments, the message is a random access response (RAR) that is received in a time window that starts after the transmissions on the plurality of random access channels are performed, and the information with which the RAR is scrambled is a random access radio network temporary identifier (RA-RNTI) that is associated with the random access channel where the transmission was performed using the transmission beam. In some embodiments, the message is a random access response (RAR) that includes an identifier of the transmission beam in a medium access control (MAC) protocol data unit (PDU). In some embodiments, the identifier of the transmission beam is included in a MAC RAR content in the MAC PDU of the RAR.

In some embodiments, the time domain location of the message is associated with a control channel monitoring occasion from a plurality of control channel monitoring occasions included in a time window, the communication device determines an identifier of the transmission beam based on a number or an index associated with the control channel monitoring occasion where the message is received, and the number or the index of the control channel monitoring occasion is part of a series of numbers or a series of indexes associated with the plurality of control channel monitoring occasions. In some embodiments, the control channel monitoring occasion is associated with a synchronization signal block (SSB), and the SSB is associated with the plurality of random access channels. In some embodiments, the identifier of the transmission beam is determined using the following equation: the identifier of the transmission beam=the number or the index associated with the control channel monitoring occasion where the message is received modulus a total number of the plurality of random access channels.

In some embodiments, the series of numbers or the series of indexes associated with the plurality of control channel monitoring occasions are counted or determined by the communication device. In some embodiments, the communication device starts counting or determines the series of number or the series of indexes of the plurality of control channel monitoring occasions from a reference point in the time window until an end of the time window. In some embodiments, the reference point is located at a starting time of the time window, or the reference point is located at a slot, a subframe, a frame, a multi-frames boundary in the time window. In some embodiments, a control resource set (CORESET) used by the message is associated with the transmission beam, or a search space set used by the message is associated with the transmission beam. In some embodiments, the message includes a demodulation reference signal (DMRS) sequence that is associated with the transmission beam. In some embodiments, the message is random access response (RAR), and the communication device receives a downlink control information (DCI) that includes an identifier of the transmission beam and that is associated with the RAR.

A second wireless communication method includes receiving, by a network device, transmissions on a plurality of random access channels from a communication device; and transmitting a message in response to the receiving the transmissions on the plurality of random access channels, where a transmission beam with which the communication device is to perform a subsequent transmission to be received by the network device is identified by information with which the message is scrambled, is identified by information included in the message, or is associated with a time domain location of the message, where the network device receives a transmission of a random access channel from the plurality of random access channels, and where the transmission beam is used for the transmission.

In some embodiments, the message is a random access response (RAR), the information with which the RAR is scrambled is a random access radio network temporary identifier (RA-RNTI), and the RA-RNTI is a function of: a symbol index of a random access channel occasion, a slot index of the random access channel occasion, a frequency index of the random access channel occasion, a carrier index of a random access channel occasion, and an identifier of the transmission beam. In some embodiments, the message is a random access response (RAR) that is transmitted in a time window that starts after the transmissions on the plurality of random access channels are received, and the information with which the RAR is scrambled is a random access radio network temporary identifier (RA-RNTI) that is associated with the random access channel where the transmission using the transmission beam is received.

In some embodiments, the message is a random access response (RAR) that includes an identifier of the transmission beam in a medium access control (MAC) protocol data unit (PDU). In some embodiments, the identifier of the transmission beam is included in a MAC RAR content in the MAC PDU of the RAR. In some embodiments, the time domain location of the message is in a control channel monitoring occasion from a plurality of control channel monitoring occasions included in a time window, an identifier of the transmission beam based on a number or an index associated with the control channel monitoring occasion where the message is transmitted, and the number or the index of the control channel monitoring occasion is part of a series of numbers or a series of indexes associated with the plurality of control channel monitoring occasions. In some embodiments, the control channel monitoring occasion is associated with a synchronization signal block (SSB), and the SSB is associated with the plurality of random access channels.

In some embodiments, the identifier of the transmission beam is based on the following equation: the identifier of the transmission beam=the number or the index associated with the control channel monitoring occasion where the message is transmitted modulus a total number of the plurality of random access channels. In some embodiments, a control resource set (CORESET) used by the message is associated with the transmission beam, or a search space set used by the message is associated with the transmission beam. In some embodiments, the message includes a demodulation reference signal (DMRS) sequence that is associated with the transmission beam. In some embodiments, the message is random access response (RAR), and the network device transmits a downlink control information (DCI) that includes an identifier of the transmission beam and that is associated with the RAR.

A third wireless communication method includes receiving, by a network device, a cyclic prefix and a plurality of preambles; transmitting, after the receiving the cyclic prefix and the plurality of preambles, a plurality of random access responses (RARs), where each RAR includes a timing advance (TA) command including a TA value that corresponds to one of a plurality of round trip delays, where each round trip delay is associated with one detection window from a plurality of detection windows, and where each detection window is associated with a reception of a different set of preambles from the plurality of preambles; receiving, in response to the transmitting the plurality of RARs, a first message based on one TA value associated with one TA command from one RAR; and transmitting, response to the receiving the first message, a second message that indicates that the first message is received.

A fourth wireless communication method includes transmitting, by a communication device, a cyclic prefix followed by a plurality of preambles in time domain; receiving, after the transmitting the cyclic prefix and the plurality of preambles, a plurality of random access responses (RARs), wherein each RAR includes a timing advance (TA) command; transmitting, in response to the receiving the plurality of RARs, a plurality of messages, where each of the plurality of messages are based on one TA value associated with one TA command from one RAR; and receiving, in response to the transmitting the plurality of messages, a message that indicates that one message is received from the communication device, wherein the one message is from the plurality of messages.

In some embodiments, the TA command of each RAR is associated with one of a plurality of round drip delays, each round trip delay is associated with one detection window from a plurality of detection windows of a network device, and each detection window is associated with a different set of preambles from the plurality of preambles. In some embodiments, the TA command includes a TA value that corresponds to one of a plurality of round trip delays.

In yet another exemplary aspect, the above-described methods are embodied in the form of processor-executable code and stored in a non-transitory computer-readable storage medium. The code included in the computer readable storage medium when executed by a processor, causes the processor to implement the methods described in this patent document.

In yet another exemplary embodiment, a device that is configured or operable to perform the above-described methods is disclosed.

The above and other aspects and their implementations are described in greater detail in the drawings, the descriptions, and the claims.

### BRIEF DESCRIPTION OF THE DRAWING

FIG. 1 shows a scenario where the user equipment (UE) transmission (Tx) and reception (Rx) beams are correspondent.

FIG. 2 shows a scenario where the UE Tx and Rx beams are not correspondent.

FIG. 3 shows a physical random access channel (PRACH) format C2.

FIG. 4 shows a UE sending the PRACH repetition with different beams before a base station transmits a random access response (RAR) to UE.

FIG. 5 shows a single RAR window corresponding to the whole PRACH transmission with repetitions, where the single RAR window starts after the end of the last symbol of the last PRACH repetition.

FIG. 6 shows that each of multiple RAR windows correspond to one of multiple PRACH repetitions.

FIG. 7 is a diagram illustrating an example of configuration of physical downlink control channel (PDCCH) monitoring occasion.

FIG. 8 shows the UE Tx beam indication using the PDCCH monitor occasion (MO) location which the UE can start counting from the start of RAR window.

FIG. 9 shows the number of PRACH repetition is same as the number of MO for RAR in one frame.

FIG. 10 shows an example of MO index period having two frames, where the index starts from the even frame and ends in the odd frame.

FIG. 11 shows the UE Tx beam indication being performed using the PDCCH MO location which the UE can count from the start of RAR window when the relationship between synchronization signal block (SSB) and MO of PDCCH has been defined.

FIG. 12 shows the legacy behavior of gNB detecting PRACH.

FIG. 13 shows a scenario where coverage limited by the cyclic prefix (CP) length is extended by using part of preambles as supplementary CP.

FIG. 14 shows the solution of ambiguity of multiple round trip delays (RTDs).

FIG. 15 shows an example procedure when PRACH repetition is applied.

FIG. 16 shows an example of wireless communication including a base station (BS) and user equipment (UE) based on some implementations of the disclosed technology.

FIG. 17 shows an exemplary block diagram of a hardware platform that may be a part of a network device or a communication device.

FIG. 18 shows an exemplary flowchart for receiving a message for identifying a transmission beam for a transmission.

FIG. 19 shows an exemplary flowchart for transmitting a message for identifying a transmission beam for a communication device.

FIG. 20 shows an exemplary flowchart for receiving a message based on a timing advance (TA) value.

FIG. 21 shows an exemplary flowchart for transmitting messages based on TA values.

### DETAILED DESCRIPTION

In mobile communication networks, e.g., New Radio (NR), the enhancement for larger coverage of cell or lower latency of access for the initial access technology is one of the main challenges. When the UE transmission beam and reception beam may not be correspondent, e.g., the UE antenna reciprocal is not satisfied, UE would try to perform random access channel (RACH) retransmission with different transmission beam after the failure of the previous RACH transmission. The retransmission will be performed until UE finds the suitable transmission beam, but the latency of initial access due to retransmission may not satisfy the system requirement.

For some large cell coverage scenarios, for example, a supreme cell which needs the cell radius more than 100 km in sub-6G Hz band, or the fixed wireless access which needs the cell radius more than 1 km in microwave band, the cell coverage is restricted by the largest cyclic prefix (CP) length which can be allowed by current physical random access channel (PRACH) format.

NR has introduced a basic scheme to support the initial access under FR1 (sub 6G Hz band) and FR2 (beyond 6G Hz band). The scheme can include different PRACH formats, PRACH resource configurations, the relationship between the SSB and PRACH, the mechanism of PRACH retransmission, the mechanism of PRACH power control, etc.

But the RACH procedure in the basic scheme only considers the UE transmission beam and reception beam are correspondent. If the UE transmission beam and reception beam are not correspondent, which is a scenario that is very likely when the UE works under millimeter wave (mm wave) band, the only way for the UE to find the suitable transmission beam is to try RACH retransmission with variant beams after the failure of the previous RACH transmission.

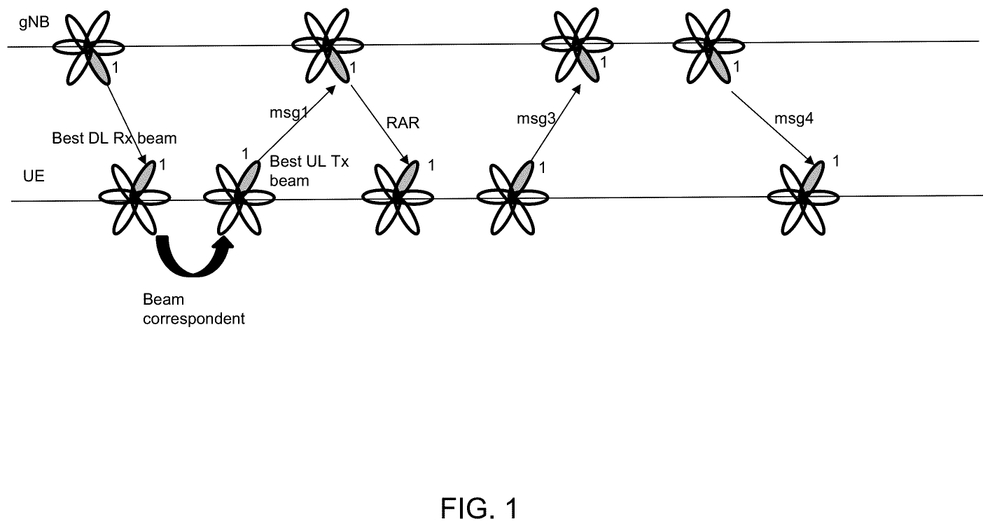

FIG. 1 shows the UE Tx and Rx beams are correspondent, the best Tx and Rx beams are the same with ID that are both “1”.

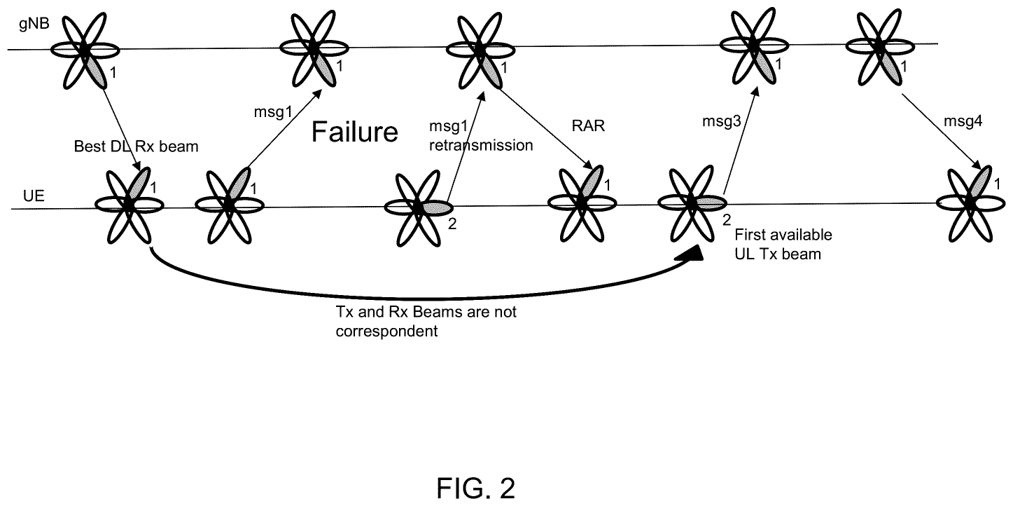

FIG. 2 shows when the UE Tx and Rx beams are not correspondent, the first available Tx beam ID is “2” but the best Rx beams ID is “1”. The first msg1 reception is failed as gNB can't receive the msg1 from the unsuitable Tx beam “1” of UE. The retransmission of msg1 is needed after failure, until the first available UL Tx beam “2” is selected. The latency of initial access is prolonged when the UE tries to find the first available Tx beams by Tx beam switching.

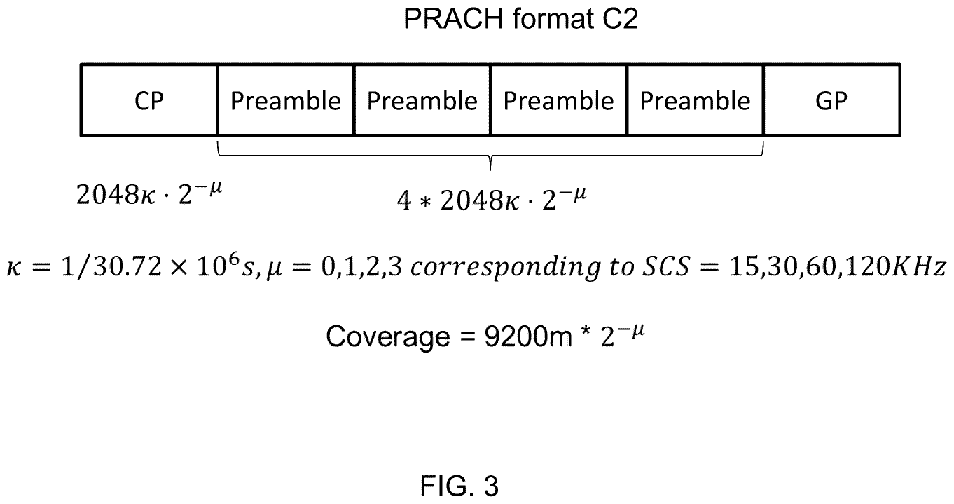

FIG. 3 shows the PRACH format C2. Current PRACH format design only considers the CP length would not exceed the length of one OFDM symbol, e.g., 2048κ·2^{-μ}, but the current CP length would not support the extreme coverage requirement. For example, the Format C2 is typically used in the mm wave band to support fixed wireless access (FWA), under the setting of subcarrier spacing (SCS) equaling 120 KHz, the CP length can support up to about 1.15 km cell radius which is less than the requirement of typical FWA scenario. In real deployment, the FWA may need up to 10 km transmission distance between the base station and UE.

The example headings for the various sections below are used to facilitate the understanding of the disclosed subject matter and do not limit the scope of the claimed subject matter in any way. Accordingly, one or more features of one example section can be combined with one or more features of another example section. Furthermore, 5G terminology is used for the sake of clarity of explanation, but the techniques disclosed in the present document are not limited to 5G technology only, and may be used in wireless systems that implemented other protocols.

### I. Embodiment #1: PRACH Repetition with Different Beams

In aforementioned, if the UE transmission beam and reception beam are not correspondent, UE has to try RACH retransmission with variant beams after each failure of the previous RACH transmission to find the suitable transmission beam. The process to find suitable transmission beam is kind of Tx beam switching based on PRACH retransmission mechanism. In order to reduce the latency of initial access, the Tx beam switching is expected to be finished within the first transmission period, no need to switch the Tx beam in next transmission period. This way is also regarded as PRACH (msg1) repetition with different beams within the first round of transmission period.

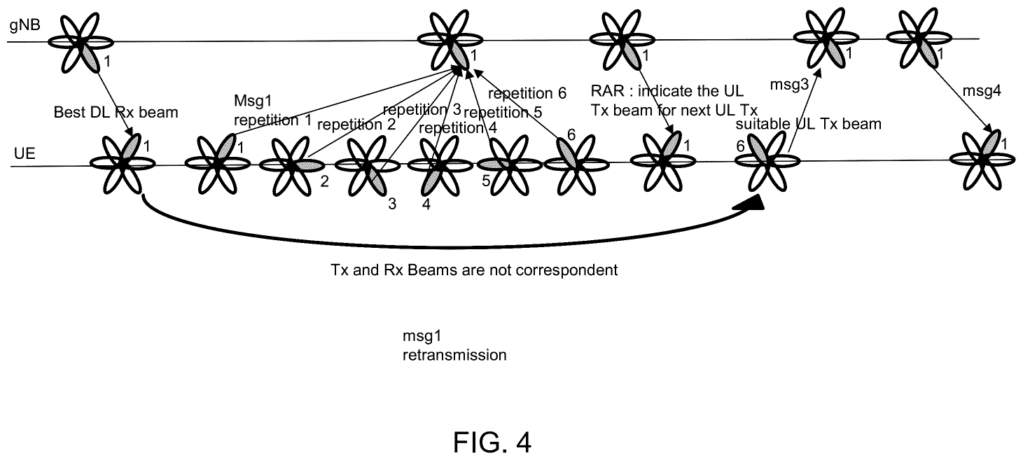

FIG. 4 shows a UE sending the PRACH repetition with different beams before a base station transmits a random access response (RAR) to UE. For example, six PRACH repetitions which share the same Preamble Index (in other embodiment, the preamble index can also be different between PRACH repetitions with different beams) are transmitted to gNB, gNB selects one suitable repetition reception, based on the reception quality such as the RSRP/SINR of PRACH, and determines the suitable UL Tx beam ID for the next UL transmission, and indicates the suitable UL Tx beam ID to UE by RAR. The suitable UL Tx beam ID may belong to the best reception of repetition e.g., from Tx beam ID “6” or the first reception of repetition whose RSRP/SINR exceeds the threshold, e.g., from Tx beam ID “2”, etc., the determination criterion depends on gNB implementation.

According to the legacy RACH procedure, RAR or msg2/msgA should be after the end of PRACH transmission, the RAR window starts at the first symbol of the earliest CORESET which the UE is configured to receive PDCCH for Type1-PDCCH CSS set, that is at least one symbol, after the last symbol of the PRACH occasion corresponding to the PRACH transmission. When PRACH repetition is applied, the determination of last symbol of the PRACH occasion can be the last symbol of the first PRACH repetition, or the last symbol of the last PRACH repetition if all the PRACH repetitions are considered as a whole PRACH/msg1 transmission. Obviously, it is better to determine the last symbol of the last PRACH repetition as the end of whole PRACH transmission. In consequence, there is only one RAR window corresponding to the whole PRACH transmission.

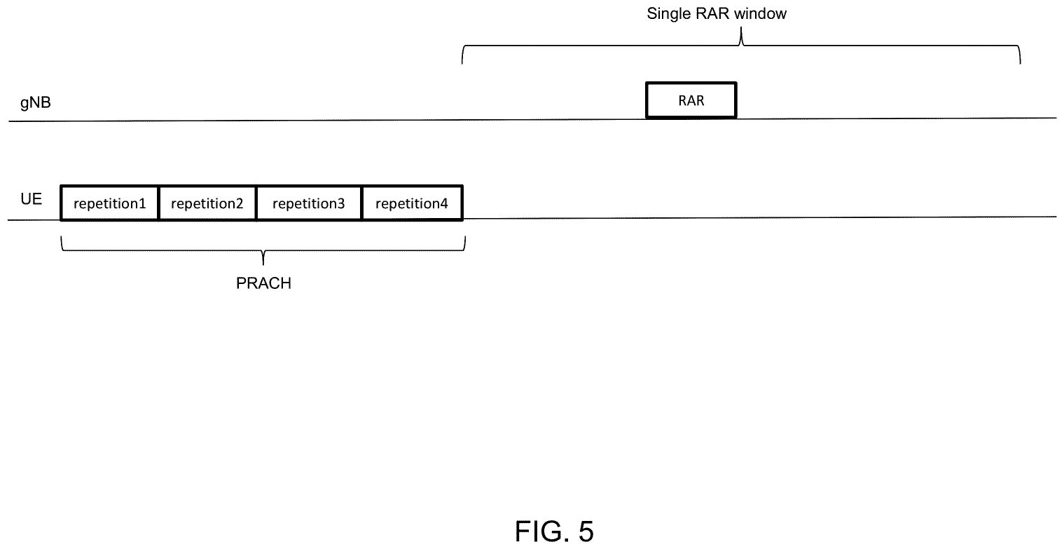

FIG. 5 shows a single RAR window corresponding to the whole PRACH transmission with repetitions, where the single RAR window starts after the end of the last symbol of the last PRACH repetition. In other words, the RAR window starts at the first symbol of the earliest CORESET which the UE is configured to receive PDCCH for Type1-PDCCH CSS set, which is at least a predefined number of symbols, after the end of the last symbol of the last PRACH occasion corresponding to the PRACH transmission.

In the other way, all the PRACH repetitions are regarded as individual PRACH transmission, and each one can have a corresponding RAR window as well based on the legacy procedure.

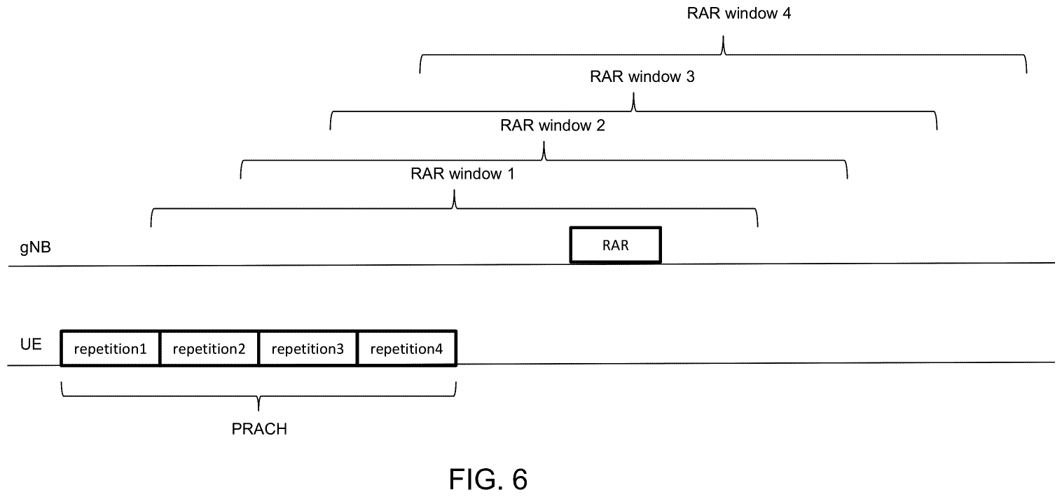

FIG. 6 shows that each of multiple RAR windows correspond to one of multiple PRACH repetitions. For example, RAR window 1 can correspond to PRACH repetition 1, RAR window 2 can correspond to PRACH repetition 2, and so on. The gNB may transmit a response to any PRACH repetition in any RAR windows. In the RAR window, the UE detects the PDCCH with scrambled by the RA-RNTI, the PDCCH is for the response message to PRACH repetition. Also, the PDSCH for response message to PRACH repetition is scrambled by RA-RNTI. The legacy RA-RNTI associated with the PRACH occasion in which the Random Access Preamble is transmitted, is computed as:

$$RA - RNTI = 1 + s\_id + 14 \times t\_id + 14 \times 80 \times f\_id + 14 \times 80 \times 8 \times u1\_carrier \_id$$

where s_id is symbol index of PRACH occasion t_id is slot index of PRACH occasion f_id is frequency index of PRACH occasion, and ul_carrier_id is carrier index of PRACH occasion. However, since the multiple RAR windows overlap with each other as shown in FIG. 6, if the UE receives a RAR in one of the RAR windows, the UE cannot easily determine which transmission beam is indicated by the PDCCH scrambled by the RA-RNTI in the RAR if RA-RNTI is calculated using the equation mentioned above. The RA-RNTI calculation can differentiate each PRACH repetition, legacy procedure is processed for each PRACH repetition just like a normal PRACH transmission.

In some other scenario where there is only one RAR window corresponding to the whole PRACH repetitions transmission with different beams, if the RA-RNTI calculation is based on the last PRACH repetition, UE can have some difficulties in differentiating which RAR corresponds to which PRACH repetition, and the UE can have difficulties in determining which UE Tx beam is suitable for gNB reception. There are several alternatives to solve the issue to differentiate the RAR belonging to which PRACH repetition.

Alternative 1: Modify the RA-RNTI Calculation with Beam ID

The legacy RA-RNTI calculation is based on the symbol index of PRACH occasion, slot index of PRACH occasion, frequency index of PRACH occasion, carrier index of PRACH occasion as mentioned above. The information about UE Tx beam ID can be added into the RA-RNTI calculation, assuming the maximum number of beam is 8, for example, the RA-RNTI calculation can be modified to:

$$RA - RNTI = 1 + s\_id + 14 \times t\_id + 14 \times 80 \times f\_id + 14 \times 80 \times 8 \times u1\_carrier \_id + 14 \times 80 \times 8 \times 8 \times beam ID$$

Alternative 2: RAR Transmission with RA-RNTI Corresponding to One of the Multiple PRACH Repetitions.

Only one RAR window is defined corresponding to the whole PRACH repetitions transmission. And the starting point of the RAR window is determined only according to the last PRACH repetition. While, one of the RA-RNTIs corresponding to the multiple PRACH repetitions can be used for scrambling the PDCCH for RAR transmission, that is, each RA-RNTI is calculated based on each PRACH repetition. There is one to one mapping between RA-RNTI and PRACH repetition, and one to one mapping between the PRACH repetition and the UE Tx beam ID. Thus, for example, each PRACH repetition can be associated with one RA-RNTI so that the UE, upon receiving an RA-RNTI, can determine a TX beam that is used to transmit a PRACH repetition corresponding to the RA-RNTI. Then, the UE Tx beam can be indicated by the RA-RNTI used to scramble the PDCCH for RAR.

### Alternative 3: Explicitly Indication in the Content of RAR

The MAC PDU for Random Access Response (RAR) consists of the MAC subPDU, padding, etc. MAC subPDU consists of MAC subheader, MAC RAR or other possible MAC structure. One alternative way is explicitly indicated the UL Tx beam in MAC PDU, specifically the indication can be added in MAC RAR content.

### Alternative 4: UE Tx Beam Indication Through the PDCCH Monitor Occasion (MO) Number or Count

In wireless communication system, a control resource set (CORESET) consists one or more resource blocks (RBs) in the frequency domain and one or more orthogonal frequency division multiplexing (OFDM) symbols in the time domain. One or more physical downlink control channel (PDCCH) candidates are transmitted in a CORESET. The configuration parameters of CORESET are configured by the network for a user equipment (UE), including CORESET index, frequency domain resource, CORESET duration, etc. One or more CORESETs may be configured for a UE to monitor the PDCCH.

The gNB can configure transmission configuration indicator (TCI) state identity for a CORESET through RRC signaling or a combination of RRC signaling and MAC signaling. The TCI state contains Quasi Co-Location (QCL) information, and the QCL information further contains at least one of: reference signal (RS) configuration information, and QCL type, etc. The RS can be a Channel State Indication RS (CSI-RS) or a synchronizing signal and Physical Broadcast Channel block (SSB), and the RS configuration information contains CSI-RS resource identity or SSB index.

For example, a list of TCI states can be configured by RRC signaling, and one of TCI states in the list can be further indicated by MAC signaling (e.g, MAC CE (control element)) for the CORESET. Then, the DMRS antenna port for PDCCH reception in the CORESET and the RS resource indicated in the TCI state is quasi co-located with the indicated QCL type. The quasi co-located is defined for two antenna ports when the large-scale properties of the channel over which a symbol on one antenna port is conveyed can be inferred from the large-scale properties of the channel over which a symbol on the other antenna port is conveyed. The large-scale properties include one or more of delay spread, Doppler spread, Doppler shift, average gain, average delay, and spatial Rx parameters.

In wireless communication system, one or more search space sets are configured by the network for a UE. The configuration parameters of a search space set include search space index, associated CORESET index, monitoringSlotPeriodicityAndOffset, duration, monitoringSymbolsWithinSlot, search space type, etc. In general, there are two types of search space, UE-specific search space (USS) and common search space (CSS). A search space type also indicates the downlink control information (DCI) formats that a UE monitors. A search space set is associated with a CORESET. RRC signaling ‘monitoringSlotPeriodicityAndOffset’ indicates the slots on which a UE needs to monitor PDCCH. According to a search space set configuration and the associated CORESET configuration, a UE is configured to monitor corresponding PDCCH with DCI formats indicated by the search space type on the resources indicated by the CORESET in the slots indicated by the monitoringSlotPeriodicityAndOffset.

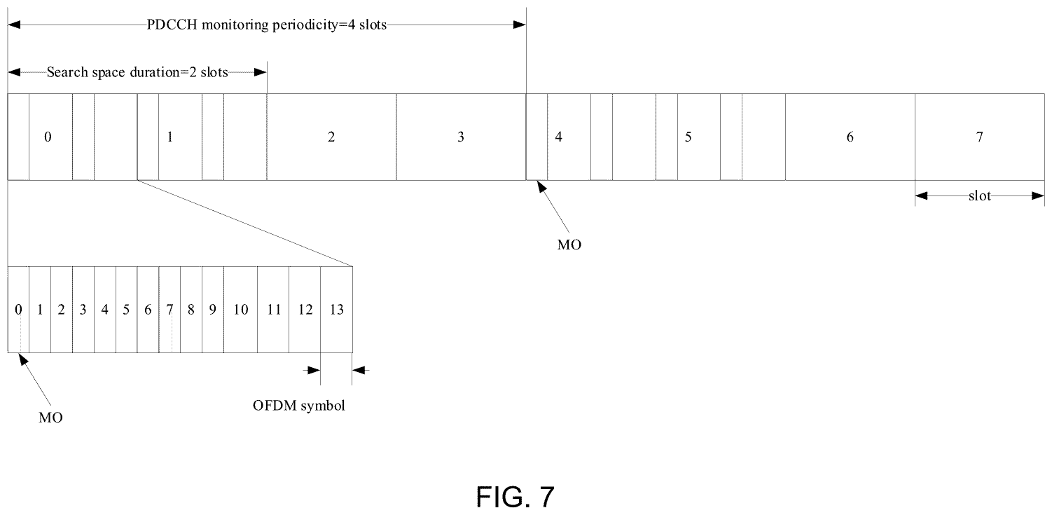

FIG. 7 is a diagram illustrating an example of configuration of PDCCH monitoring occasion. Eight slots are illustrated overall (denoted by slot 0-7). PDCCH monitoring period is 4 slots and offset is 0. The search space duration is 2, which means two consecutive slots containing the PDCCH monitoring occasion (MO) within a PDCCH monitoring period. The positions of PDCCH MOs within each slot are configured via RRC signaling ‘monitoringSymbolsWithinSlot’. It is configured that 2 PDCCH MOs in a slot. Therefore, there are totally 4 MOs within one PDCCH monitoring period. On each of MOs, there are one resource configured by CORESET for UE to monitor PDCCH.

In wireless communication system, there are one or more PDCCH candidates in one search space. Each PDCCH candidate have a PDCCH candidate index. A PDCCH consists of one or more control-channel elements (CCEs). Each CCE have a CCE index.

Within the RAR window, gNB can freely select the position of PDCCH MO for RAR transmission. The relationship between the PDCCH MO and the UE Tx beam ID can be helpful for UE to determine the UE Tx beam ID for subsequent UL transmission. For example, within the RAR window, the window length is 10 ms, there are many PDCCH MOs for Type1-PDCCH CSS set, it is assumed the maximum number of UE Tx beams is 8, e.g., each UE Tx beam has Tx beam index m, which belongs {0, . . . , 7}, There are N MOs within the RAR window, and MOs starting from the RAR window starting point can be indexed to 0, 1, 2, 3, 4, 5, 6, 7, . . . , N−1, following the ordinary order of PDCCH MOs. When UE successfully receives the RAR with the MO index n, n is {0 . . . N−1}, UE will have the knowledge of the UE Tx beam ID m for subsequent UL transmission. The index can be implicitly determined by UE counting from the first PDCCH MO after the starting point of RAR window. Specifically, UE counts the number of PDCCH MO and calculates the remainder from the division of counting number or index of PDCCH MO where RAR is received by the number of PRACH repetitions. The UE can determine UE Tx beam ID based on the following equation:

UE Tx beam ID m=(counting or number or index of PDCCH MO n where RAR is received)Mod(number of PRACH repetitions)

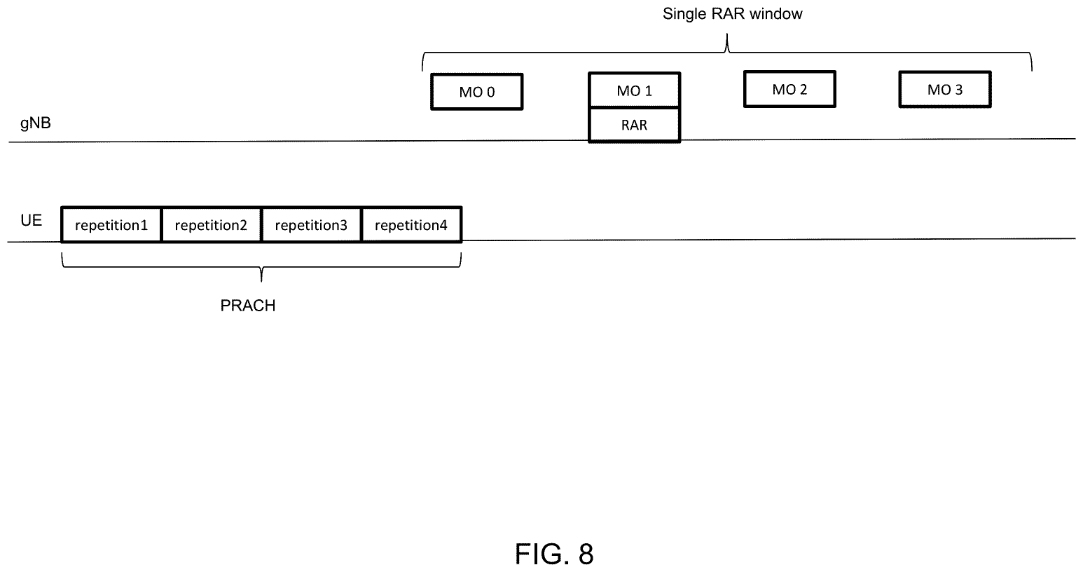

FIG. 8 shows the UE Tx beam indication using the PDCCH MO location which the UE can start counting from the start of RAR window. In this example, the UE Tx beam ID “1” is selected by gNB and indicated to UE by the RAR transmission located in MO index “1”. Thus, in some embodiments, if the UE receives a RAR from the gNB on MO 1, then the UE can determine that the UE Tx beam ID of “1” is being indicated by the gNB.

UE determines the suitable Tx beam based on the relationship between the PDCCH MO for RAR and the UE Tx beam ID. UE counts all the PDCCH MO for RAR starting from the reference point, the counting is ascending up to the number of PRACH repetition and cycled back to the first counting value, the cycling counting is ended until the end of reference window (which is the RAR window). When the UE gets the valid RAR from the PDCCH MO, the UE Tx beam index for next UL transmission is determined by the counting value (or number) of the corresponding PDCCH MO.

The counting or number of MO can also start from the slot/subframe/frame boundary but not the start of RAR window. The index of MO is relative fixed with the time period boundary of frame structure, it can be easy for UE counting and less complexity is needed.

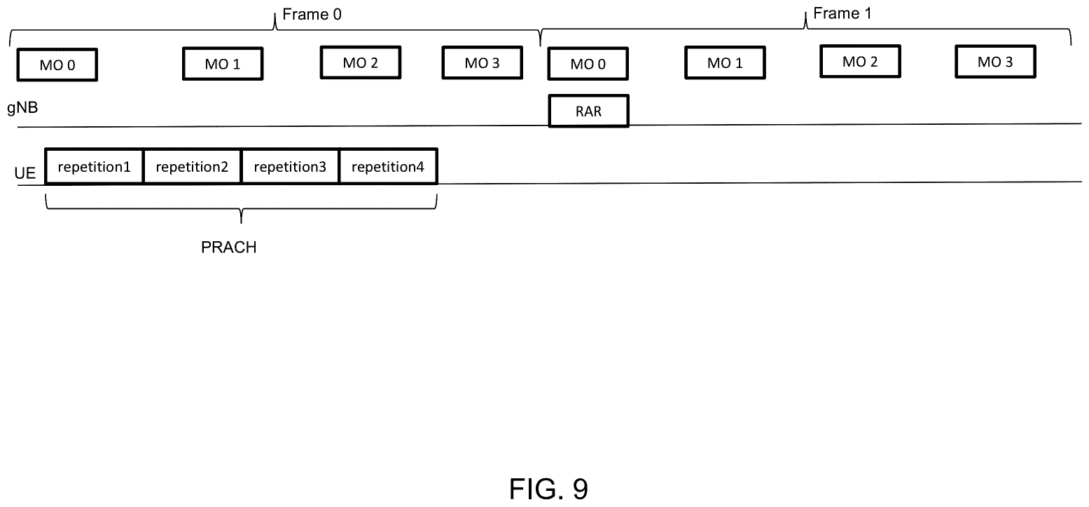

FIG. 9 shows the number of PRACH repetition is same as the number of MO for RAR in one frame. The MO indexes are repeated every frame. In this example, the RAR is transmitted in MO 0, this means gNB selects the UE Tx beam ID 0 corresponding to PRACH repetition 1.

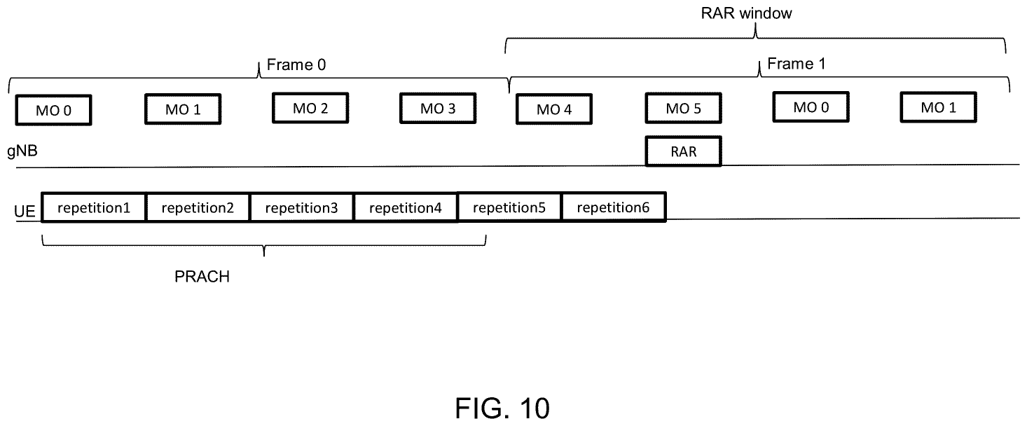

FIG. 10 shows an example of MO index period having two frames, the index starts from the even frame and ends in the odd frame. As the number of PRACH repetition exceeds the number of MO provided in one frame, two-frame period for MO indexing is applied. In this example, the RAR is transmitted in MO 5, this means gNB selects the UE Tx beam ID 5 corresponding to PRACH repetition 6. One thing should be noted that, as RAR window length is typical 10 ms which is same with frame length, this is possible that some RARs can't find the suitable MO to be transmitted within the RAR window, for example, gNB selects the UE Tx beam ID 2 corresponding to PRACH repetition 3, but UE can't find MO2 in the RAR window. To solve this issue, one way is gNB should make sure in one frame period, sufficient MOs for RAR should be provided. The other way is to expand the RAR window length, for example, to set double, triple or longer RAR window length based on the original length of 10 ms.

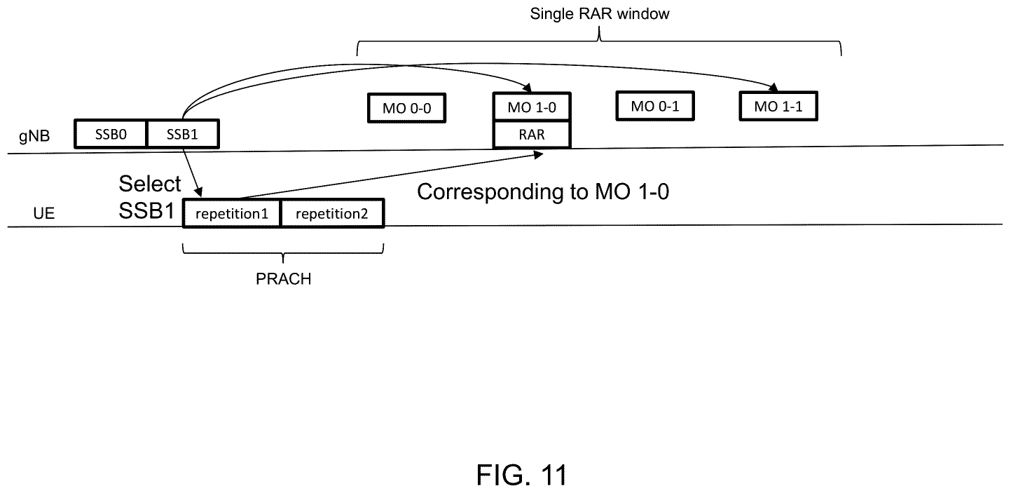

FIG. 11 shows the UE Tx beam indication being performed using the PDCCH MO location which the UE can count from the start of RAR window when the relationship between synchronization signal block (SSB) and MO of PDCCH has been defined.

The relationship between SSB and MO of PDCCH has been defined, the downlink transmission of each MO will use the downlink beam corresponding to each SSB. In the RACH procedure, UE will select a SSB first, the MO for PDCCH is also determined based on the association between the MO and SSB. UE determines the suitable Tx beam based on the relationship between the PDCCH MO for RAR and the UE Tx beam ID. UE counts all the PDCCH MO for RAR which is associated to the selected SSB starting from the reference point until the end of reference window (or end of RAR window). The reference point for starting the counting can be the starting time of RAR window or the slot/subframe/frame/multi-frames boundary. The UE performs a modulus on the counting or the counting or current number or index of MO where the RAR is received by the total number of PRACH repetition (or the total number of random access channels) and derives the UE Tx beam ID. When the UE gets the valid RAR from the PDCCH MO, the UE Tx beam index for subsequent UL transmission is determined by the modulus on the counting of the corresponding PDCCH MO.

For example, the MO 0-0, MO 0-1 in FIG. 11 are related to the SSB0; MO 1-0, MO 1-1 are related to the SSB1 separately. UE firstly selects the SSB1 and determine the PRACH based on the SSB1. The UE can only monitor the MO of PDCCH in MO 1-0 and MO 1-1. When UE detects the RAR in MO 1-0, it means the UE Tx beam is indicated as first Tx beam.

### Alternative 5: UE Tx Beam Indication Through the CORESET or Search Space Set Configuration

For different PRACH repetitions, different CORESET and/or search space set can be configured. Then, if a UE detects a RAR PDCCH in a CORESET or search space set, then, the UE can determine the best UE Tx beam, which corresponds with the CORESET or search space set.

### Alternative 6: UE Tx Beam Indication Through DMRS Sequence of RAR PDCCH/PDSCH

The relationship between UE Tx beam and DMRS sequence of RAR PDCCH/PDSCH can be predefined or configured by the gNB (e.g., through SIB1). Then, if a UE detects a RAR PDCCH/PDSCH, it can determine the best UE Tx beam, which corresponds with the DMRS of the detected RAR PDCCH/PDSCH. The RAR may include DMRS sequence for PDCCH and/or PDSCH.

### Alternative 7: UE Tx Beam Indication Through DCI Content of PDCCH of RAR.

The UE Tx beam indication is explicitly indicated in the DCI content of PDCCH of RAR. DCI is the downlink control information with many information bits carried by PDCCH.

In some embodiments, the solution for UE to differentiate the RAR corresponding to any PRACH repetition and to decide which UE Tx beam is suitable is illustrated as below three alternatives:
Alternative 1: Modify the RA-RNTI calculation, additional information about UE Tx beam ID is added into the RA-RNTI calculation.
Alternative 2: RAR transmission with RA-RNTI corresponding to one of the multiple PRACH repetitions.
Alternative 3: explicitly indication in the content of RAR. gNB indicates the UL Tx beam in MAC PDU, specifically in MAC RAR content.
Alternative 4: UE Tx beam indication through the PDCCH MO (Monitor occasion) counting
   UE can determine the suitable Tx beam based on the relationship between the PDCCH MO for RAR and the UE Tx beam ID. UE counts all the PDCCH MO for RAR starting from the reference point until the end of reference window. It performs a modulus on the counting by a total number of PRACH repetition (or a total number of random access channels) and derives the UE Tx beam ID. When the UE gets the valid RAR from the PDCCH MO, the UE Tx beam index for subsequent UL transmission is determined by the modulus on the counting of the corresponding PDCCH MO.
   The reference point for starting the counting can be the starting time of RAR window or the slot/subframe/frame/multi-frames boundary. The reference window can be RAR window or slot/subframe/frame/multi-frames.
Alternative 5: UE Tx beam indication through the CORESET or search space set configuration
Alternative 6: UE Tx beam indication through DMRS sequence of RAR PDCCH/PDSCH
Alternative 7: UE Tx beam indication through DCI content of PDCCH of RAR

### II. Embodiment #2: Multiple Reception of RAR to Enhance the Coverage

As an introduction, for an example scenario that may include the extreme coverage requirement, a cyclic prefix (CP) length can be the main obstacle to enhance the coverage as the CP length should not exceed the length of one OFDM symbol, e.g., 2048κ·2^{-μ}.

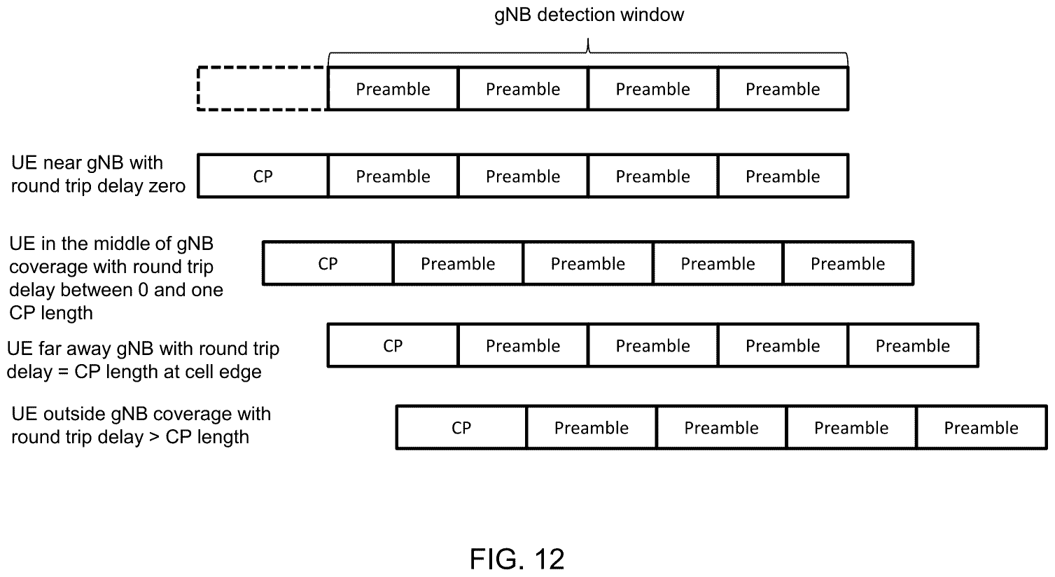

FIG. 12 shows the legacy behavior of gNB detecting PRACH. The gNB has only one hypothesis that the PRACH detection window covers the four preambles time zone which should be arrived. Four kinds of reception status can be concluded in the order of the figure that: (1) UE is very near the gNB with round trip delay (RTD) equaling zero; (2) UE is in the middle of gNB coverage with RTD between 0 and one CP length; (3) UE is far away from gNB at cell edge with RTD equaling CP length; (4) UE is outside of gNB coverage, the extra delay causes the PRACH detection is not complete and gNB has the risk of not successfully detecting the PRACH.

One solution to extend the coverage limited by the CP length is to use part of preambles as supplementary CP, e.g., some forepart preambles are pretended as the CP by gNB. Assuming the solution is based on the current PRACH format C2, this PRACH format consists of one CP with length 2048κ·2^{-μ} and 4 same continuous preambles with total length4*2048κ·2^{-μ}, under the setting of SCS equaling 120 KHz, one CP length can support up to about 1.15 km cell radius; one CP+one preamble length can support up to about 2*1.15=2.3 km cell radius; one CP+two preamble length can support up to about 3*1.15=3.45 km cell radius; one CP+three preamble length can support up to about 4*1.15=4.6 km cell radius. For the other PRACH format, e.g., Format B4 with one CP and 12 preambles, the maximum supported cell radius can reach to 0.48+11*1.15=13.13 km.

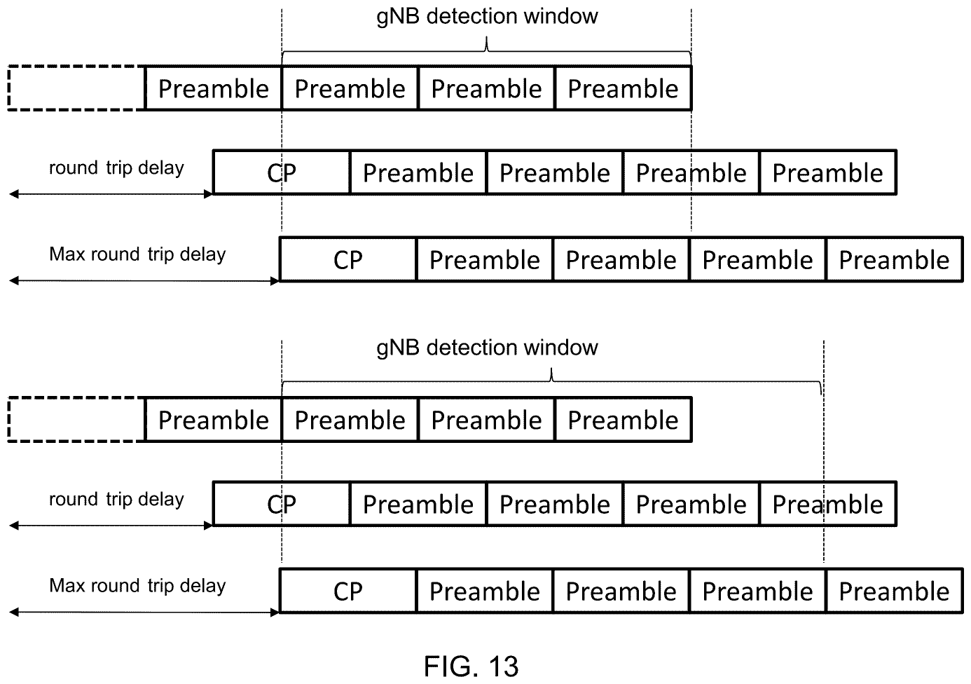

Under this solution, the gNB at least has two hypotheses on the CP length, one is the legacy understanding that only traditional CP is regarded as CP. The other is that one CP+one preamble are assumed as total CP by gNB. In this way, the coverage can be doubled. If more preambles are involved in the CP, coverage can be enhanced proportionally. The detailed example can be illustrated by FIG. 13. FIG. 13 shows a scenario where coverage limited by the CP length is extended by using part of preambles as supplementary CP. The hypothesis of gNB in FIG. 13 is that one CP+one preamble are assumed as total CP. RTD is extended at most to the sum of the CP length and preamble length. In FIG. 13, the detection window starts from the second preamble, the length of detection window can be the left sum of preambles, e.g., three preamble length, or keep the same length of detection window of the first hypothesis, e.g., four preambles length.

The question of the solution is if gNB holds two hypotheses on the CP length, when it detects the PRACH, due to the different UE locations in cell, there may be two detection energy peaks of PRACH detection under the two hypotheses, which leads two possible RTD results. The gNB can't distinguish the validity of the two RTD estimation results in the step 1 of random access. More hypothesis held by gNB, more possible RTD estimation results. In traditional RACH procedure, multiple RTD estimations are regarded as false alarm of PRACH detection. If gNB produces multiple RARs based on multiple RTD estimations, RACH procedure can't move on to the next steps as UE only has the capability to detect only one RAR belonging to this UE within the RAR window. The legacy UE behavior is UE will stop the RAR detection if one RAR is successfully detected and confirmed belonging to this UE according to preamble index verification. UE is very likely to get the wrong TA (timing advance) command based on the wrong RTD estimation, and it can be predicted that the msg3 reception will fail based on the wrong TA command.

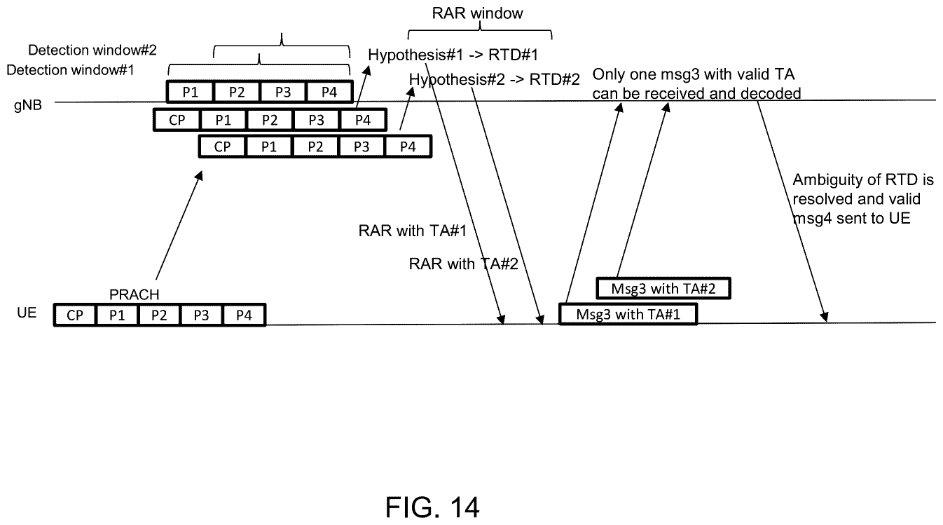

FIG. 14 shows the solution of ambiguity of multiple RTDs. To solve the ambiguity issue due to multiple hypothesis on CP length or assumption of PRACH detection window by gNB, UE need have the capability to receive and decode multiple RARs within one RAR window, e.g., UE will not stop the RAR detection even if one RAR is confirmed successfully and will continue to detect the RARs until the end of RAR window. When UE gets multiple RARs, UE will follow the TA command of multiple RARs, and sends multiple msg3 based on multiple TA commands which are related to multiple RTD estimations. The TA command in each of the multiple RAR includes a TA value. Thus, for example, each of the multiple msg3 are transmitted using the TA value associated with one of the multiple RAR. The gNB will try to receive all the msg3 but it actually could only successfully receive one msg3 with the valid TA corresponding to the true RTD estimation. Then the ambiguity of multiple RTD estimations are resolved by multiple msg3 transmissions followed by multiple RARs receptions. In FIG. 14, msg4 is sent by gNB to the UE to indicate to the UE that the gNB has received msg3, where the msg4 may include an acknowledgement (ACK) message.

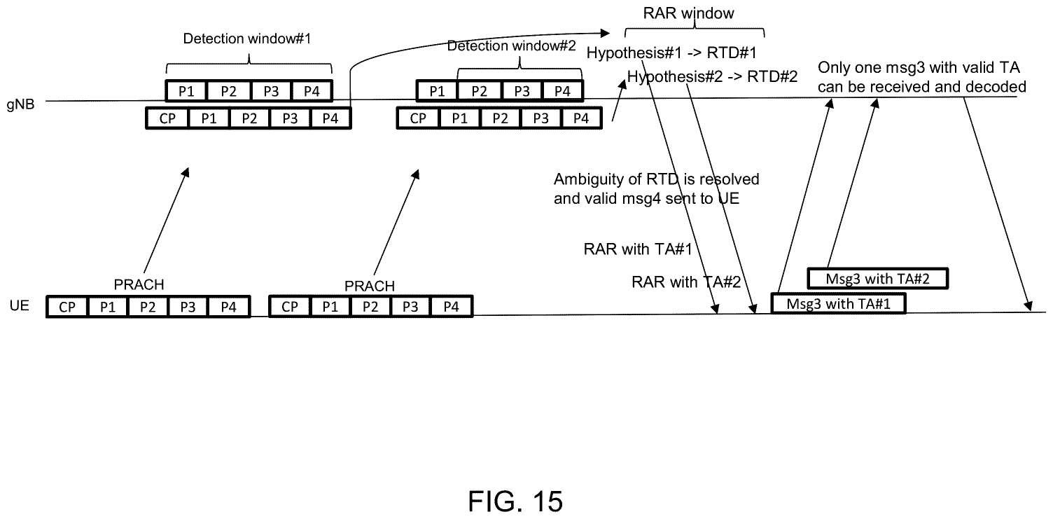

FIG. 15 shows an example procedure when PRACH repetition is applied. If the PRACH repetition is applied, for example, PRACH repeats two times in the time domain, it means gNB may not need do the preamble detection based on the two hypothesis simultaneously, it can detect the first repetition with first hypothesis, and detect the second repetition with the second hypothesis later. The gNB need response to the two repetitions with multiple RARs separately. The other procedures are the same with above example.

In some embodiments, the techniques described in Section II of this patent document can enhance the coverage. In some embodiments, gNB assumes the different CP length of PRACH (original CP length, extended CP length including part of preambles) and assume multiple hypothesis of PRACH arrival time zone by setting different parallel PRACH reception windows, corresponding to the assumption of different CP length; gNB may get multiple RTD estimation with ambiguity during PRACH detection; gNB sends multiple RARs with different TA commands to UE according to different RTD estimation; gNB tries to receive all the msg3 corresponding to the UL grants in the RAR with different TA command and gets one valid msg3 at most, and then the ambiguity of RTD is resolved by the reception of msg3 with valid TA.

For UE, it should not stop the RAR detection even if one RAR is confirmed successfully and continue to detect all the possible RARs until the end of RAR window. When UE gets multiple RARs belonging to it, UE should follow the command in the UL grants in multiple RARs, and sends multiple msg3 based on multiple TA commands which are related to multiple RTD estimations. In FIG. 15, after the gNB receives an msg3, the gNB transmits to the UE a message (e.g., msg4) to indicate to the UE that the gNB has received msg3, where the msg4 may include an acknowledgement (ACK) message.

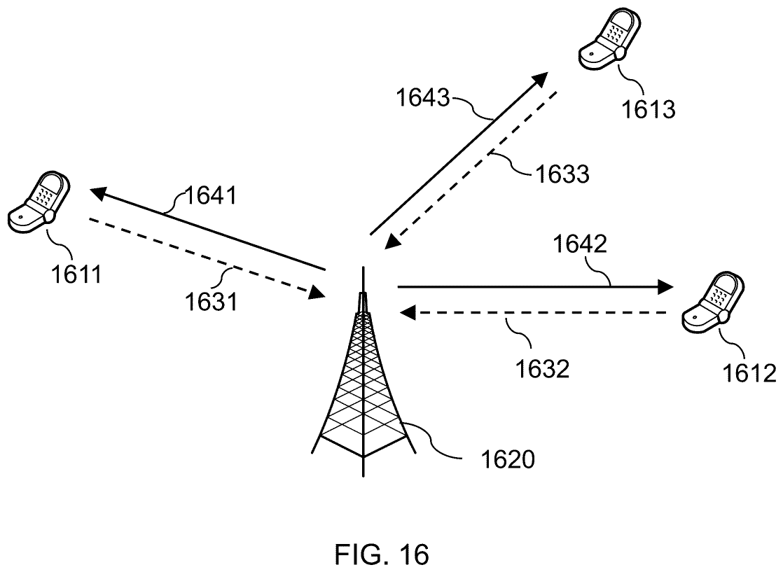

The implementations as discussed above will apply to a wireless communication. FIG. 16 shows an example of a wireless communication system (e.g., a 5G or NR cellular network) that includes a base station 1620 and one or more user equipment (UE) 1611, 1612 and 1613. In some embodiments, the UEs access the BS (e.g., the network) using a communication link to the network (sometimes called uplink direction, as depicted by dashed arrows 1631, 1632, 1633), which then enables subsequent communication (e.g., shown in the direction from the network to the UEs, sometimes called downlink direction, shown by arrows 1641, 1642, 1643) from the BS to the UEs. In some embodiments, the BS send information to the UEs (sometimes called downlink direction, as depicted by arrows 1641, 1642, 1643), which then enables subsequent communication (e.g., shown in the direction from the UEs to the BS, sometimes called uplink direction, shown by dashed arrows 1631, 1632, 1633) from the UEs to the BS. The UE may be, for example, a smartphone, a tablet, a mobile computer, a machine to machine (M2M) device, an Internet of Things (IoT) device, and so on.

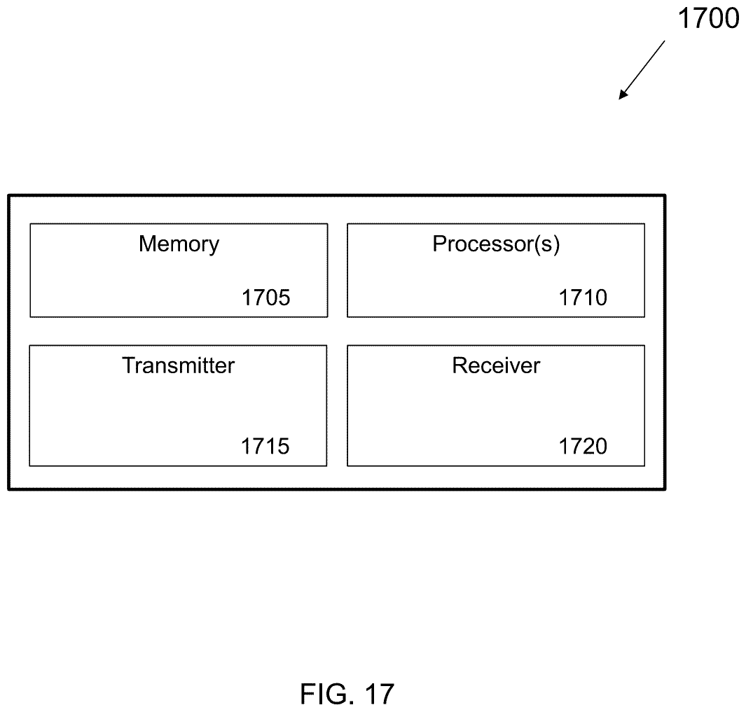

FIG. 17 shows an exemplary block diagram of a hardware platform 1700 that may be a part of a network device (e.g., base station) or a communication device (e.g., a user equipment (UE)). The hardware platform 1700 includes at least one processor 1710 and a memory 1705 having instructions stored thereupon. The instructions upon execution by the processor 1710 configure the hardware platform 1700 to perform the operations described in FIGS. 1 to 16 and 18 to 21 and in the various embodiments described in this patent document. The transmitter 1715 transmits or sends information or data to another device. For example, a network device transmitter can send a message to a user equipment. The receiver 1720 receives information or data transmitted or sent by another device. For example, a user equipment can receive a message from a network device.

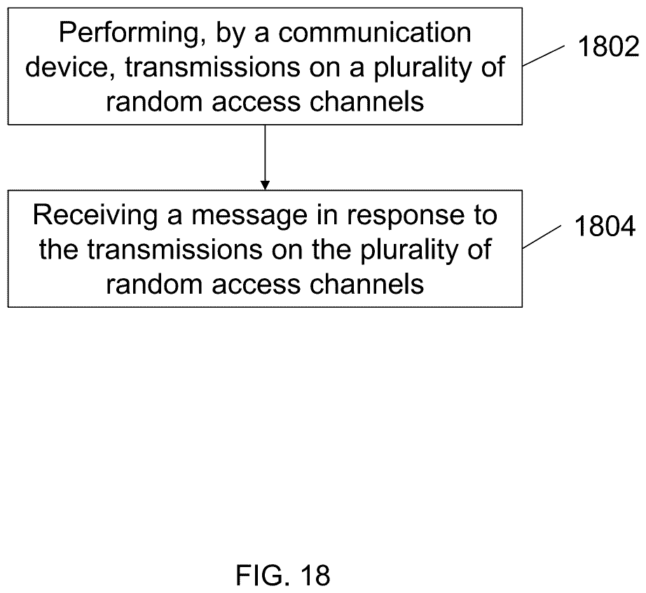

FIG. 18 shows an exemplary flowchart for receiving a message for identifying a transmission beam for a transmission. Operation 1802 includes performing, by a communication device, transmissions on a plurality of random access channels. Operation 1804 includes receiving a message in response to the transmissions on the plurality of random access channels, where a transmission beam with which the communication device is to perform a subsequent transmission after the message is received is identified by information with which the message is scrambled, is identified by information included in the message, or is associated with a time domain location of the message, and where the transmission beam is used for a transmission of a random access channel from the plurality of random access channels.

In some embodiments, the message is a random access response (RAR), the information with which the RAR is scrambled is a random access radio network temporary identifier (RA-RNTI), and the RA-RNTI is a function of: a symbol index of a random access channel occasion, a slot index of the random access channel occasion, a frequency index of the random access channel occasion, a carrier index of a random access channel occasion, and an identifier of the transmission beam. In some embodiments, the message is a random access response (RAR) that is received in a time window that starts after the transmissions on the plurality of random access channels are performed, and the information with which the RAR is scrambled is a random access radio network temporary identifier (RA-RNTI) that is associated with the random access channel where the transmission was performed using the transmission beam. In some embodiments, the message is a random access response (RAR) that includes an identifier of the transmission beam in a medium access control (MAC) protocol data unit (PDU). In some embodiments, the identifier of the transmission beam is included in a MAC RAR content in the MAC PDU of the RAR.

In some embodiments, the time domain location of the message is associated with a control channel monitoring occasion from a plurality of control channel monitoring occasions included in a time window, the communication device determines an identifier of the transmission beam based on a number or an index associated with the control channel monitoring occasion where the message is received, and the number or the index of the control channel monitoring occasion is part of a series of numbers or a series of indexes associated with the plurality of control channel monitoring occasions. In some embodiments, the control channel monitoring occasion is associated with a synchronization signal block (SSB), and the SSB is associated with the plurality of random access channels. In some embodiments, the identifier of the transmission beam is determined using the following equation: the identifier of the transmission beam=the number or the index associated with the control channel monitoring occasion where the message is received modulus a total number of the plurality of random access channels.

In some embodiments, the series of numbers or the series of indexes associated with the plurality of control channel monitoring occasions are counted or determined by the communication device. In some embodiments, the communication device starts counting or determines the series of number or the series of indexes of the plurality of control channel monitoring occasions from a reference point in the time window until an end of the time window. In some embodiments, the reference point is located at a starting time of the time window, or the reference point is located at a slot, a subframe, a frame, a multi-frames boundary in the time window. In some embodiments, a control resource set (CORESET) used by the message is associated with the transmission beam, or a search space set used by the message is associated with the transmission beam. In some embodiments, the message includes a demodulation reference signal (DMRS) sequence that is associated with the transmission beam. In some embodiments, the message is random access response (RAR), and the communication device receives a downlink control information (DCI) that includes an identifier of the transmission beam and that is associated with the RAR.

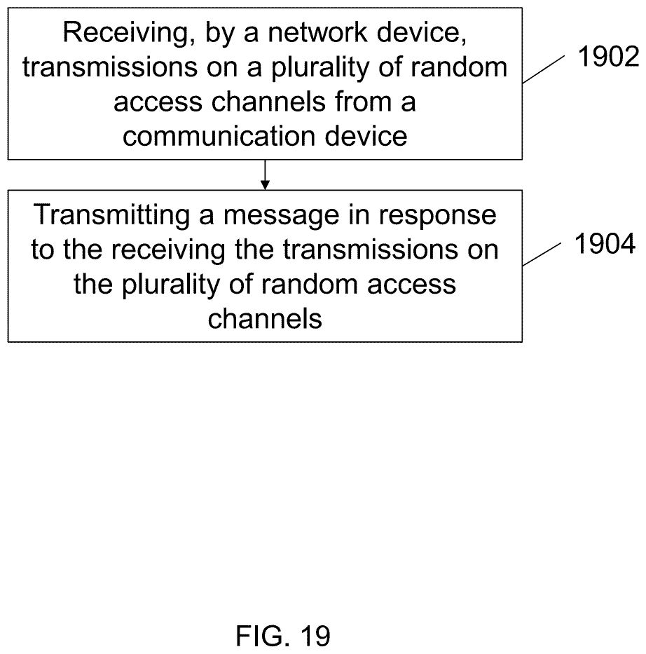

FIG. 19 shows an exemplary flowchart for transmitting a message for identifying a transmission beam for a communication device. Operation 1902 includes receiving, by a network device, transmissions on a plurality of random access channels from a communication device. Operation 1904 includes transmitting a message in response to the receiving the transmissions on the plurality of random access channels, where a transmission beam with which the communication device is to perform a subsequent transmission to be received by the network device is identified by information with which the message is scrambled, is identified by information included in the message, or is associated with a time domain location of the message, where the network device receives a transmission of a random access channel from the plurality of random access channels, and where the transmission beam is used for the transmission.

In some embodiments, the message is a random access response (RAR), the information with which the RAR is scrambled is a random access radio network temporary identifier (RA-RNTI), and the RA-RNTI is a function of: a symbol index of a random access channel occasion, a slot index of the random access channel occasion, a frequency index of the random access channel occasion, a carrier index of a random access channel occasion, and an identifier of the transmission beam. In some embodiments, the message is a random access response (RAR) that is transmitted in a time window that starts after the transmissions on the plurality of random access channels are received, and the information with which the RAR is scrambled is a random access radio network temporary identifier (RA-RNTI) that is associated with the random access channel where the transmission using the transmission beam is received.

In some embodiments, the message is a random access response (RAR) that includes an identifier of the transmission beam in a medium access control (MAC) protocol data unit (PDU). In some embodiments, the identifier of the transmission beam is included in a MAC RAR content in the MAC PDU of the RAR. In some embodiments, the time domain location of the message is in a control channel monitoring occasion from a plurality of control channel monitoring occasions included in a time window, an identifier of the transmission beam based on a number or an index associated with the control channel monitoring occasion where the message is transmitted, and the number or the index of the control channel monitoring occasion is part of a series of numbers or a series of indexes associated with the plurality of control channel monitoring occasions. In some embodiments, the control channel monitoring occasion is associated with a synchronization signal block (SSB), and the SSB is associated with the plurality of random access channels.

In some embodiments, the identifier of the transmission beam is based on the following equation: the identifier of the transmission beam=the number or the index associated with the control channel monitoring occasion where the message is transmitted modulus a total number of the plurality of random access channels. In some embodiments, a control resource set (CORESET) used by the message is associated with the transmission beam, or a search space set used by the message is associated with the transmission beam. In some embodiments, the message includes a demodulation reference signal (DMRS) sequence that is associated with the transmission beam. In some embodiments, the message is random access response (RAR), and the network device transmits a downlink control information (DCI) that includes an identifier of the transmission beam and that is associated with the RAR.

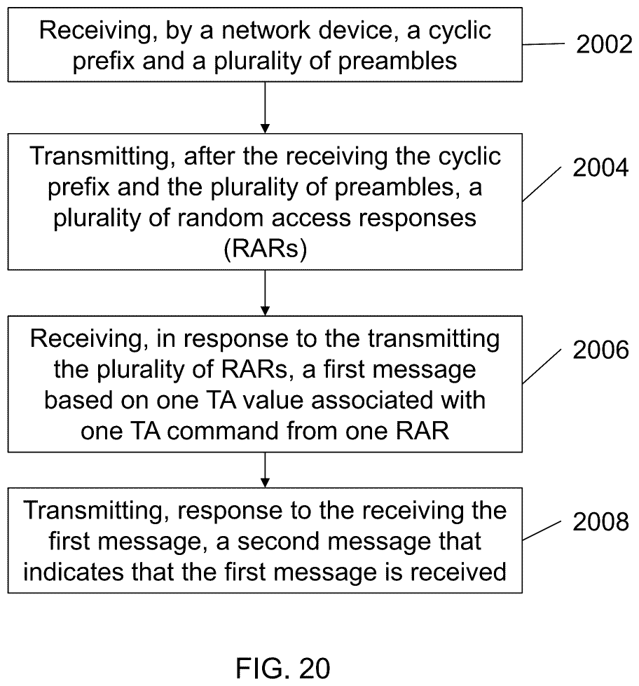

FIG. 20 shows an exemplary flowchart for receiving a message based on a timing advance (TA) value. Operation 2002 includes receiving, by a network device, a cyclic prefix and a plurality of preambles. Operation 2004 includes transmitting, after the receiving the cyclic prefix and the plurality of preambles, a plurality of random access responses (RARs), where each RAR includes a timing advance (TA) command including a TA value that corresponds to one of a plurality of round trip delays, where each round trip delay is associated with one detection window from a plurality of detection windows, and where each detection window is associated with a reception of a different set of preambles from the plurality of preambles. Operation 2006 includes receiving, in response to the transmitting the plurality of RARs, a first message based on one TA value associated with one TA command from one RAR. Operation 2008 includes transmitting, response to the receiving the first message, a second message that indicates that the first message is received.

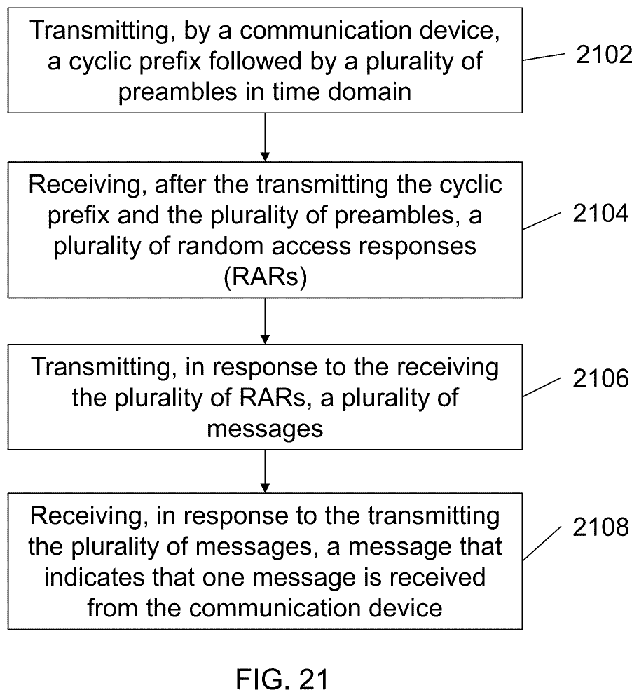

FIG. 21 shows an exemplary flowchart for transmitting messages based on TA values. Operation 2102 includes transmitting, by a communication device, a cyclic prefix followed by a plurality of preambles in time domain. Operation 2104 includes receiving, after the transmitting the cyclic prefix and the plurality of preambles, a plurality of random access responses (RARs), wherein each RAR includes a timing advance (TA) command. Operation 2106 includes transmitting, in response to the receiving the plurality of RARs, a plurality of messages, where each of the plurality of messages are based on one TA value associated with one TA command from one RAR. Operation 2108 includes receiving, in response to the transmitting the plurality of messages, a message that indicates that one message is received from the communication device, wherein the one message is from the plurality of messages.

In some embodiments, the TA command of each RAR is associated with one of a plurality of round drip delays, each round trip delay is associated with one detection window from a plurality of detection windows of a network device, and each detection window is associated with a different set of preambles from the plurality of preambles. In some embodiments, the TA command includes a TA value that corresponds to one of a plurality of round trip delays.

In this document the term “exemplary” is used to mean “an example of” and, unless otherwise stated, does not imply an ideal or a preferred embodiment.

Some of the embodiments described herein are described in the general context of methods or processes, which may be implemented in one embodiment by a computer program product, embodied in a computer-readable medium, including computer-executable instructions, such as program code, executed by computers in networked environments. A computer-readable medium may include removable and non-removable storage devices including, but not limited to, Read Only Memory (ROM), Random Access Memory (RAM), compact discs (CDs), digital versatile discs (DVD), etc. Therefore, the computer-readable media can include a non-transitory storage media. Generally, program modules may include routines, programs, objects, components, data structures, etc. that perform particular tasks or implement particular abstract data types. Computer- or processor-executable instructions, associated data structures, and program modules represent examples of program code for executing steps of the methods disclosed herein. The particular sequence of such executable instructions or associated data structures represents examples of corresponding acts for implementing the functions described in such steps or processes.

Some of the disclosed embodiments can be implemented as devices or modules using hardware circuits, software, or combinations thereof. For example, a hardware circuit implementation can include discrete analog and/or digital components that are, for example, integrated as part of a printed circuit board. Alternatively, or additionally, the disclosed components or modules can be implemented as an Application Specific Integrated Circuit (ASIC) and/or as a Field Programmable Gate Array (FPGA) device. Some implementations may additionally or alternatively include a digital signal processor (DSP) that is a specialized microprocessor with an architecture optimized for the operational needs of digital signal processing associated with the disclosed functionalities of this application. Similarly, the various components or sub-components within each module may be implemented in software, hardware or firmware. The connectivity between the modules and/or components within the modules may be provided using any one of the connectivity methods and media that is known in the art, including, but not limited to, communications over the Internet, wired, or wireless networks using the appropriate protocols.

While this document contains many specifics, these should not be construed as limitations on the scope of an invention that is claimed or of what may be claimed, but rather as descriptions of features specific to particular embodiments. Certain features that are described in this document in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or a variation of a sub-combination. Similarly, while operations are depicted in the drawings in a particular order, this should not be understood as requiring that such operations be performed in the particular order shown or in sequential order, or that all illustrated operations be performed, to achieve desirable results.

Only a few implementations and examples are described and other implementations, enhancements and variations can be made based on what is described and illustrated in this disclosure.

What is claimed is:

1. A wireless communication method, comprising:
performing, by a communication device, transmissions on a plurality of random access channels; and
receiving a message in response to the transmissions on the plurality of random access channels,
wherein a transmission beam with which the communication device is to perform a subsequent transmission after the message is received is associated with a time domain location of the message, and
wherein the transmission beam is used for a transmission of a random access channel from the plurality of random access channels.

2. The method of claim 1, wherein the message is a random access response (RAR) that includes an identifier of the transmission beam in a medium access control (MAC) protocol data unit (PDU).

3. The method of claim 2, wherein the identifier of the transmission beam is included in a MAC RAR content in the MAC PDU of the RAR.

4. The method of claim 1,
wherein the time domain location of the message is associated with a control channel monitoring occasion from a plurality of control channel monitoring occasions included in a time window,
wherein the communication device determines an identifier of the transmission beam based on a number or an index associated with the control channel monitoring occasion where the message is received, and
wherein the number or the index of the control channel monitoring occasion is part of a series of numbers or a series of indexes associated with the plurality of control channel monitoring occasions.

5. The method of claim 4, wherein the control channel monitoring occasion is associated with a synchronization signal block (SSB), and the SSB is associated with the plurality of random access channels.

6. The method of claim 4, wherein the identifier of the transmission beam is determined using the following equation:
the identifier of the transmission beam=the number or the index associated with the control channel monitoring occasion where the message is received modulus a total number of the plurality of random access channels.

7. The method of claim 4, wherein the series of numbers or the series of indexes associated with the plurality of control channel monitoring occasions are counted or determined by the communication device.

8. The method of claim 7, wherein the communication device starts counting or determines the series of number or the series of indexes of the plurality of control channel monitoring occasions from a reference point in the time window until an end of the time window.

9. A wireless communication method, comprising:
receiving, by a network device, transmissions on a plurality of random access channels from a communication device; and
transmitting a message in response to the receiving the transmissions on the plurality of random access channels,
wherein a transmission beam with which the communication device is to perform a subsequent transmission to be received by the network device is associated with a time domain location of the message,
wherein the network device receives a transmission of a random access channel from the plurality of random access channels, and
wherein the transmission beam is used for the transmission.

10. The method of claim 9, wherein the message is a random access response (RAR) that includes an identifier of the transmission beam in a medium access control (MAC) protocol data unit (PDU).

11. The method of claim 10, wherein the identifier of the transmission beam is included in a MAC RAR content in the MAC PDU of the RAR.

12. The method of claim 9,
wherein the time domain location of the message is in a control channel monitoring occasion from a plurality of control channel monitoring occasions included in a time window,
wherein an identifier of the transmission beam based on a number or an index associated with the control channel monitoring occasion where the message is transmitted, and
wherein the number or the index of the control channel monitoring occasion is part of a series of numbers or a series of indexes associated with the plurality of control channel monitoring occasions.

13. The method of claim 12, wherein the control channel monitoring occasion is associated with a synchronization signal block (SSB), and the SSB is associated with the plurality of random access channels.

14. The method of claim 12, wherein the identifier of the transmission beam is based on the following equation:
the identifier of the transmission beam=the number or the index associated with the control channel monitoring occasion where the message is transmitted modulus a total number of the plurality of random access channels.

15. A communication device for wireless communication comprising one or more processors configured to cause the communication device to:
perform transmissions on a plurality of random access channels; and
receive a message in response to the transmissions on the plurality of random access channels,
wherein a transmission beam with which the communication device is to perform a subsequent transmission after the message is received is associated with a time domain location of the message, and
wherein the transmission beam is used for a transmission of a random access channel from the plurality of random access channels.

16. The communication device of claim 15, wherein the message is a random access response (RAR) that includes an identifier of the transmission beam in a medium access control (MAC) protocol data unit (PDU).

17. The communication device of claim 16, wherein the identifier of the transmission beam is included in a MAC RAR content in the MAC PDU of the RAR.

18. A network device for wireless communication comprising one or more processors configured to cause the network device to:
receive transmissions on a plurality of random access channels from a communication device; and
transmitting a message in response to the receiving the transmissions on the plurality of random access channels,
wherein a transmission beam with which the communication device is to perform a subsequent transmission to be received by the network device is associated with a time domain location of the message,
wherein the network device receives a transmission of a random access channel from the plurality of random access channels, and
wherein the transmission beam is used for the transmission.

19. The network device of claim 18, wherein the message is a random access response (RAR) that includes an identifier of the transmission beam in a medium access control (MAC) protocol data unit (PDU).

20. The network device of claim 19, wherein the identifier of the transmission beam is included in a MAC RAR content in the MAC PDU of the RAR.
